(19) United States
(12) Patent Application Publication
(10) Pub. No.: US 2006/0168153 A1
(43) Pub. Date: Jul. 27, 2006

(54) Method of configuring wireless device

(76) Inventor: Ben Lin, Taipei (TW)

Correspondence Address: LIN & ASSOCIATES INTELLECTUAL PROPERTY, P.O. BOX 2339, SARATOGA, CA, 95070-0339, US

(21) Appl. No.: 10/988,736

(22) Filed: Nov. 13, 2004

(51) Int. Cl. G06F 15/177

(52) U.S. Cl. 709/220

(57) ABSTRACT

A method for efficiently setting up a wireless local area network comprising one or more access points and one or more wireless client devices is provided. Unlike traditional approaches for setting up a wireless local area network, which involves repetitive manual configuration of every AP and wireless client device, the proposed method basically stores the relevant configuration information in a removable storage media during the configuration of an AP. The removable storage media then can be used to configure the other APs and the wireless client devices with very limited human intervention. The configuration effort and the possibility of human error are therefore reduced to the minimum.

### BACKGROUND OF THE INVENTION

1. Field of the Invention

The present invention generally relates to wireless local area networks and, more particularly, to a method of configuring wireless devices for setting up wireless local area networks.

2. The Prior Arts

Local area networks (LANs) have become the ubiquitous mechanism for linking computing devices within a limited space such as homes and offices. In recent years, wireless local area networks (WLANs) with easy installation and low cost rapidly grow in popularity. The WLANs offer a way to avoid tangled messes of cables associated with typical wired LANs such as Ethernet. While wiring a business or home often requires stringing many cables through walls and ceilings, WLANs cut down on the number of cables strung or, in some cases, remove them entirely. WLANs also give users greater mobility freeing them from sticking to a computer tied to the wall. The recent advancement in terms of hardware and software, such as many computers now have built-in WLAN interfaces, also helps contributing the popularity of WLAN.

FIG. 1 is a schematic diagram illustrating a typical WLAN and its various components. With reference to FIG. 1, a typical WLAN contains one or more access points (APs) 10 located between a physical network 20 and a wireless network 30. The AP contains a wireless network interface (not shown in FIG. 1) for communicating with one or more wireless client devices 32 within the radio coverage of the wireless interface. The wireless client devices 32 may include, but not limited to, desktop computers, notebook computers, PDAs, and wireless printer servers. The AP 10 and the wireless client devices 32 within the AP 10's coverage constitute the wireless network 30. The AP 10 also contains a physical network interface (not shown in FIG. 1) for communicating with one or more cabled client devices 22 over one or more transmission media 24 including, but not limited to, coaxial cable, copper wires, and fiber optical cables. The cabled client device 22 may include, but not limited to, desktop computers, notebook computers, networked printers, and network attached storage (NAS). The AP 10, the cabled client devices 22, and the transmission media 24 constitute the physical network 20. The physical network 20 may further contains one or more cabled networking devices 26 for interconnecting the physical network 20 with other networks such as the public Internet 40. The cabled networking devices 26 may include, but not limited to, routers, cable modems, and ADSL modems. The AP 10 therefore functions as a gateway device for transmitting data from the physical network 20 to the wireless network 30 and vice versa. During the transmission process, the AP 10 intercepts data on the physical network 20 targeted toward the wireless client devices 32 on the wireless network 30, converts the data into a format required by the communication protocol of the wireless network 30, and sends out the data via the wireless network interface. Similarly, the AP 10 intercepts data on the wireless network 30 targeted toward the cabled client devices 22 on the physical network 20, converts the data into a format required by the communication protocol of the physical network 20, and sends out the data via the physical network interface and the transmission media 24.

To set up the wireless network 30, the AP 10 first must be installed and configured correctly so that it can properly communicate with the cabled client devices 22 and the cabled networking device 26. Then each of wireless client devices 32 of the wireless network 30 must be installed and configured correctly so that it can properly communicate with the AP 10.

The configuration of the AP 10 includes, but not limited to, the AP's SSID, the AP's address (whether it is a fixed address or dynamically obtained from another cabled client device 22 on the physical network 20 such as a DHCP server), the communication channel for communicating with wireless client devices, and the security mechanism used for the wireless network to be built up (such as whether to turn on the Wired Equivalent Privacy protocol and the encryption key used).

For a wireless client device 32 to become part of the wireless network 30 and to be able to communicate with other client devices or even the public Internet 40, the wireless client device 32 must have a built-in or external wireless communication interface connected to the wireless client device 32 via a certain device interface including, but not limited to, PCI bus interface (for installing a PCI-based wireless interface card), Universal Serial Bus (USB) (for an external wireless interface device connected via USB) and PCMCIA (for a PCMCIA interface card inserted into a PCMCIA slot). The wireless client device 32 must also have a driver software module installed so that the wireless client device 32's operating system can drive the wireless communication interface to work correctly. The wireless client device 32's operating system usually provides a user interface so that a user can manually configure the various parameters controlling the wireless client device 32's networking capability via the wireless communication interface. Under certain circumstance, the wireless client device 32 (such as a wireless printer server) may not have a built-in human-machine interface such as display and keyboard for user to configure the various parameters. In such case, the user has to use another computing device having a human-machine interface to connect to the wireless client device first, via device interfaces such as serial port, LAN port, and USB. Then, through the computing device, the user can manually configure the wireless client device 32.

Traditionally such a manual configuration process through the user interface has to be repeated for every wireless client device 32, which is both time-consuming and error-prone. As such, a need exists for an improved method for setting up WLANs.

### SUMMARY OF THE INVENTION

The present invention satisfies these and other needs, as will be apparent from the teachings herein.

In an embodiment of the present invention, the AP is provided with a software module stored in a chip including, but not limited to, ROM and Flash memory. The software module provides a web interface so that any cabled client device equipped with a browser program on the physical network can connect to the AP by specifying the AP's network address.

Via the web interface, the software module not only allows a user of the connecting cabled client device to configure its operation parameters, but also can package a set of configuration information including, but not limited to, AP identification and security key used for data encryption, download the set of configuration information into the cabled client device, and save in a removable storage media of the cabled client device. The removable storage media includes, but not limited to, a floppy disk, a recordable laser disk such as CD-RW, a USB flash drive, and a USB hard disk drive. The set of configuration information can be packaged into one of several forms including, but not limited to, an executable program with the set of configuration information encapsulated that can be executed on an AP or a wireless client device, an executable program along with a data file containing the set of configuration information that can be executed on an AP or a wireless client device, a data file containing the set of configuration information in a format that can be recognized by an AP's or a wireless client device's operating system, and a data file containing the set of configuration information in a format that can be recognized by a configuration program installed in an AP or a wireless client device. These packages of the configuration information are referred to as configuration modules hereinafter. In alternative embodiments of the present invention, multiple configuration modules of different forms can be saved into a single removable storage media together.

The removable storage media containing the configuration module is then placed into or connected to an AP or a wireless client device to be joined into the wireless network. If the configuration module is an executable program with encapsulated configuration information or with a separate data file, the AP or the wireless client device then executes the executable program (automatically or manually) and its wireless network or communication interface is configured automatically. If the set of configuration information is packaged as a data file recognizable by the operating system or another software program, the operating system's configuration utility or the software program is invoked (automatically or manually) to access the set of configuration information contained in the data file, and the AP or the wireless client device is then configured automatically.

Compared to traditional wireless networks, the method provided by the present invention combines the configuration of the APs and the wireless client devices in a single operation. For every AP and every wireless client device to join a WLAN, as long as it is able to access and recognize the removable storage media and the packaged configuration information stored in the removable storage media, the AP's wireless network interface and the wireless client device's wireless communication interface could be set up automatically and there is very limited human intervention involved, if any. Besides the significant reduction of the configuration effort especially when there are a large number of APs and wireless client devices, another advantage of the present invention is that, as the configuration process is automated as much as possible, the possibility of human error is reduced to the minimum.

Other objects and features of the present invention will become apparent from the following detailed description, considered in conjunction with the accompanying drawings. It is understood, however, that the drawings are designed solely for the purpose of illustration and not as a definition of the limits of the invention, for which reference should be made to the appended claims.

### BRIEF DESCRIPTION OF THE DRAWINGS

FIG. 1 is a schematic diagram illustrating a typical WLAN and its various components.

FIG. 2 is a flowchart illustrating the process of configuring wireless devices according to the first embodiment of the present invention.

FIGS. 3(a) to 3(e) are schematic diagrams illustrating the WLAN after the processing steps of FIG. 2 respectively.

FIG. 4 is a flowchart illustrating the process of configuring wireless devices according to the second embodiment of the present invention.

FIG. 5 is a flowchart illustrating the process of configuring wireless devices according to the third embodiment of the present invention.

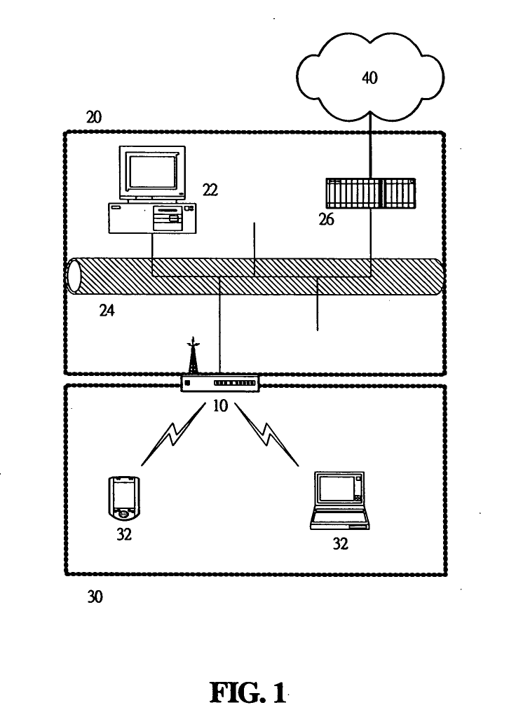

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

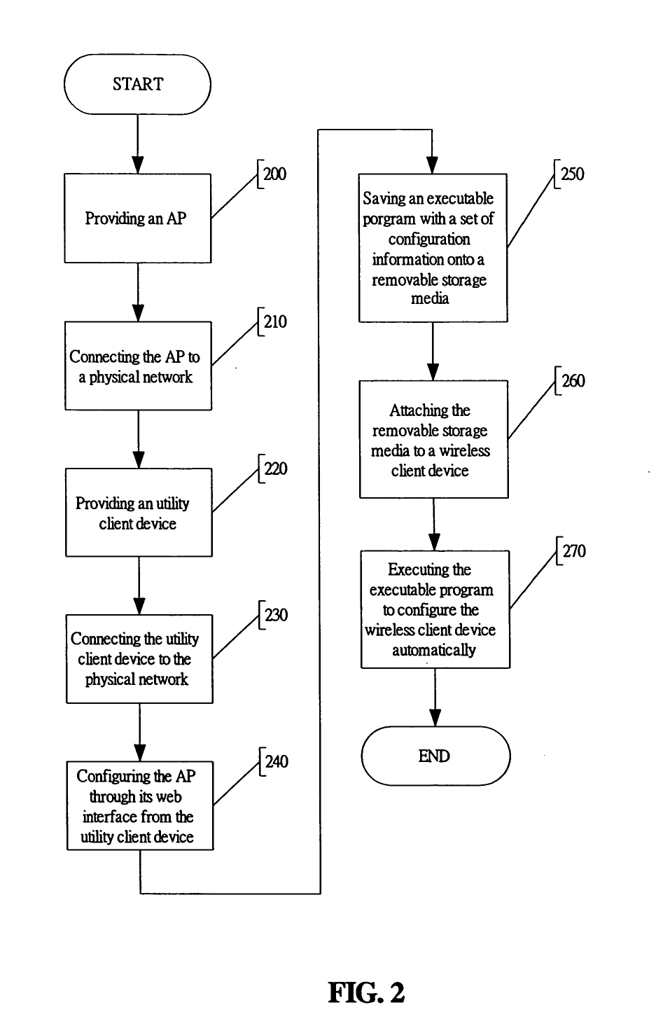

FIG. 2 is a flowchart illustrating the process of configuring wireless devices according to the first embodiment of the present invention. With reference to FIG. 2, the method starts with step 200, which provides an AP having a default address, a physical network interface, a wireless network interface, and a built-in configuration software module stored in a non-volatile memory device such as a ROM or Flash memory inside the AP. The configuration software module provides a web interface for a user to configure the AP's operation parameters. The configuration software module would, under the user's trigger (i.e., a mouse click or a keystroke) on a control of the web interface, package a pre-determined set of configuration information relevant to the setup of an AP's wireless network interface and a wireless client device's wireless communication interface into a configuration module, download the configuration module to the computing device that the user uses to connect to the AP, and saves the configuration module into a removable storage media of the computing device. More details about the configuration software module will be given later.

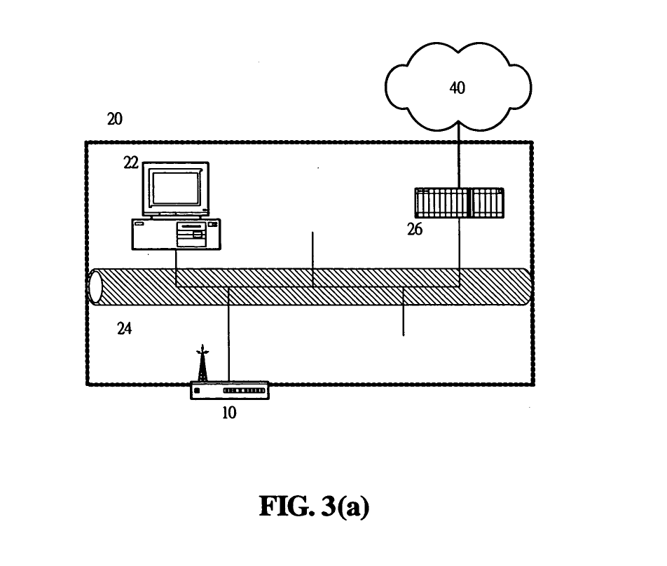

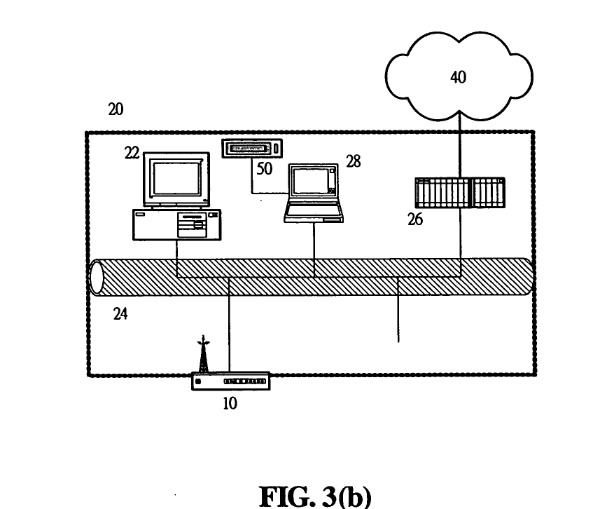

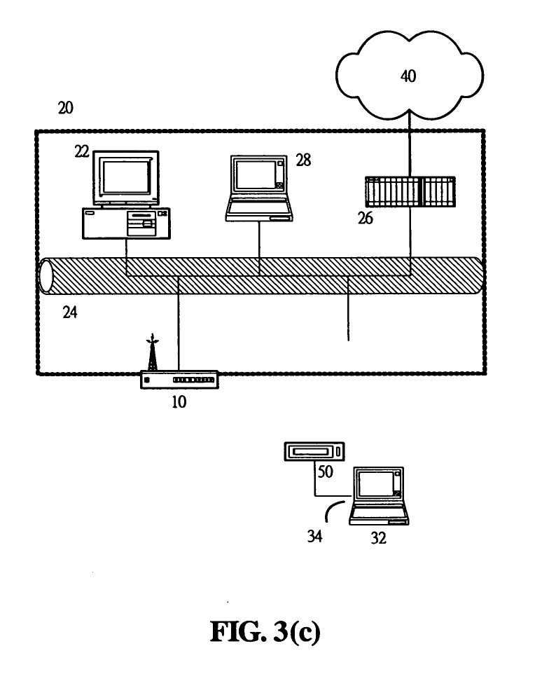

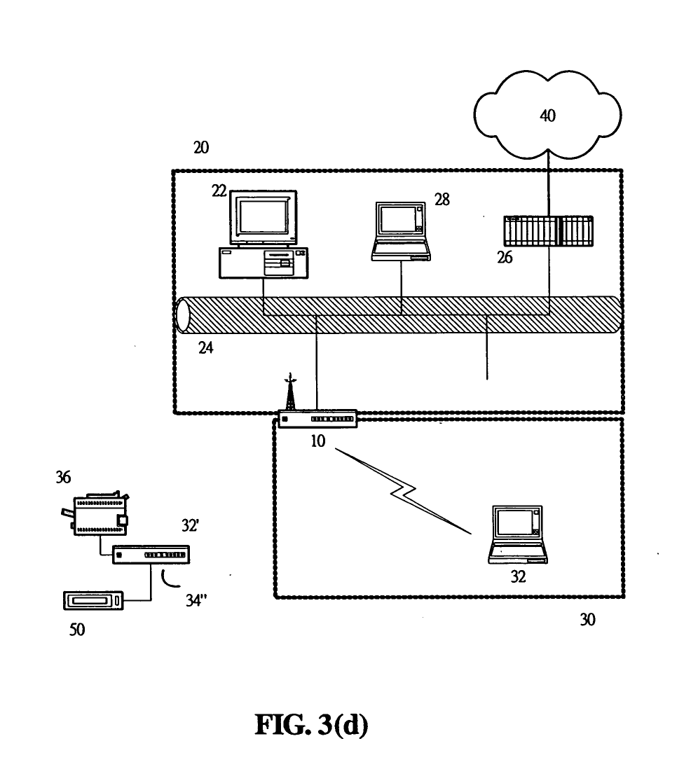

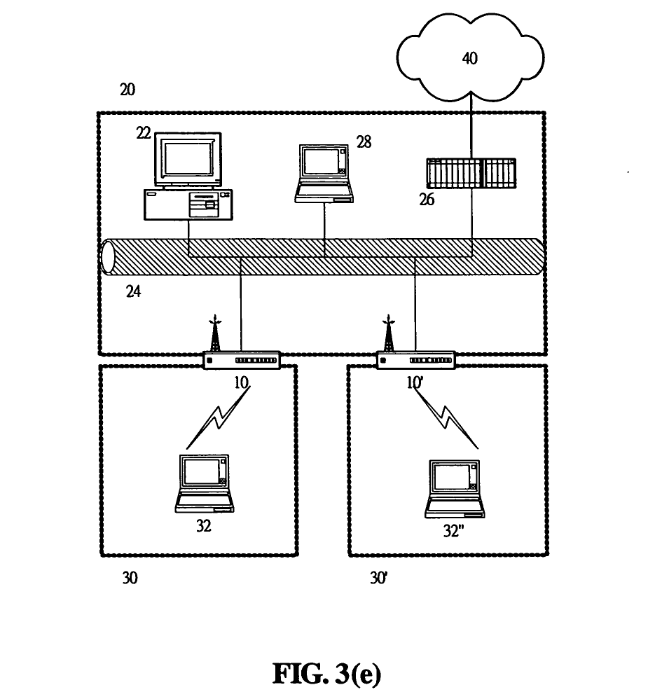

Next, in step 210, the AP is connected to a physical network. As shown in FIG. 3(a), which is a schematic diagram illustrating the WLAN after step 210 is performed, the physical network 20 comprises a transmission media 24 and one or more cabled client devices 22. The transmission media 24 may include, but not limited to, coaxial cable, copper wires, and fiber optical cables. The cabled client device 22 may include, but not limited to, desktop computers, notebook computers, networked printers, and networked storage (such as NAS). The physical network 20 may further contains one or more cabled networking devices 26 for interconnecting the physical network 20 with other networks such as the public Internet 40. The cabled networking devices 26 may include, but not limited to, routers, cable modems, and ADSL modems. In step 210, the AP 10 is physically connected to the physical network 20 using the same transmission media 24 via the AP's physical network interface (not shown).

Processing proceeds from step 210 to step 220, where another utility client device 28, which is a type of the cabled client device but has a human-machine interface such as a notebook computer, a physical network interface, a built-in browser program, and a removable storage media 50, is provided. Then, in step 230, the utility client device 28 is connected to the physical network 20 using the same transmission media 24 via the utility client device 28's physical network interface (not shown). Please also refer to FIG. 3(b), which is a schematic diagram illustrating the WLAN after step 230 is performed. The removable storage media 50 includes, but not limited to, a floppy disk, a recordable laser disk such as CD-RW, a USB flash drive, and a USB hard disk drive.

The process proceeds from step 230 to step 240. In step 240, the browser program in the utility client device 28 is executed, and a connection to the AP 10 is established by specifying the AP 10's default address in the browser program. Within the web interface provided by the AP 10's configuration software module and displayed on the utility client device 28's human-machine interface by the browser program, a user (not shown) of the utility client device is able to configure the operation parameters of the AP 10. The operation parameters include, but not limited to, the AP 10's SSID, the AP 10's address (the user can specify a fixed address other than its default address, or instruct the AP 10 to dynamically obtain one from another cabled client device 22 on the physical network 20 such as a DHCP server), the communication channel for communicating with the wireless client devices, and the security mechanism used for the wireless network to be built up (such as whether to turn on the Wired Equivalent Privacy protocol and the encryption key used).

In step 250, a copy of a pre-determined set of configuration information relevant to the configuration of other APs and the wireless client devices afterwards, under the trigger of the user of the utility client device 28, is packaged into an configuration module (not shown). The configuration module is then downloaded to the browser program of the utility client device 28 and saved onto the removable storage media 50. On the web interface, the AP 10's configuration software module provides a number of controls with which the user could select the types of the configuration module and the removable storage media appropriate for the AP and the wireless client devices to be set up later, and activate the packaging/downloading/saving operations. The packaging/downloading/saving operations can also be conducted in a later session or repeated multiple times in separate sessions, after the AP 10's operation parameters are configured. In the present embodiment the configuration module contains an executable program with the configuration information encapsulated by the AP 10's configuration software module. When the configuration module is saved, the removable storage media 50 could be detached from the utility client device 28. In an alternative embodiment, the configuration module packaged and saved could contain, instead of a single executable program, an executable program and a separate data file containing the set of configuration information.

Next, in step 260, the removable storage media 50 is inserted into a wireless client device 32 to be connected to the AP 10 in a wireless network. Please be noted that the present invention could be applied to the configuration of APs as well but a wireless client device is used as an example for simplicity. Please also refer to FIG. 3(c), which is a schematic diagram illustrating the WLAN after step 260 is performed. The wireless client devices 32 may include, but not limited to, desktop computer, notebook computers, PDAs, and wireless printer servers. In the earlier step 250, the user has selected the appropriate removable storage media 50 so that the wireless client device 32 is able to accept, recognize, and access the removable storage media 50. More specifically, the wireless client device 32 has a device interface 34 such as USB to accept the removable storage media 50. Also in the earlier step 250, the user has selected the appropriate execution program format so that the wireless client device 32 should also be able to execute the executable program in the configuration module.

Then, in step 270, the executable program is executed either manually by a user through a human-machine interface of the wireless client device 32 (such as by pressing a button on the wireless printer server or by using the keyboard and display of a PC), or automatically by the operating system of the wireless client device 32, after detecting the presence of the configuration module (such as when an USB flash drive containing the configuration module is plugged into an USB port of a notebook computer). The set of configuration information encapsulated in the executable program is used automatically by the executable program to set up the wireless communication interface of the wireless client device 32. In an alternative embodiment where the set of configuration information is saved in a separate data file along with the executable program, the content of the data file is automatically used to set up the wireless client device 32. If there are more wireless client devices to set up, the steps 260, 270 are repeated. Please also refer to FIG. 3(d), which is a schematic diagram illustrating the WLAN after step 270 is performed. As shown in FIG. 3(d), after the successful connection set up between a wireless client device 32 and the AP 10, the removable storage media 50 is removed from the wireless client device 32 and inserted into the device interface 34′ of another wireless client device 32′, which is a wireless printer server attached to a printer 36.

If the WLAN contains additional APs 10′ and other wireless client devices 32″ that may form another wireless network 30′, as shown in FIG. 3(e), the steps 260 and 270 could be repeated on and applied to the APs 10′ and the wireless client devices 32″.

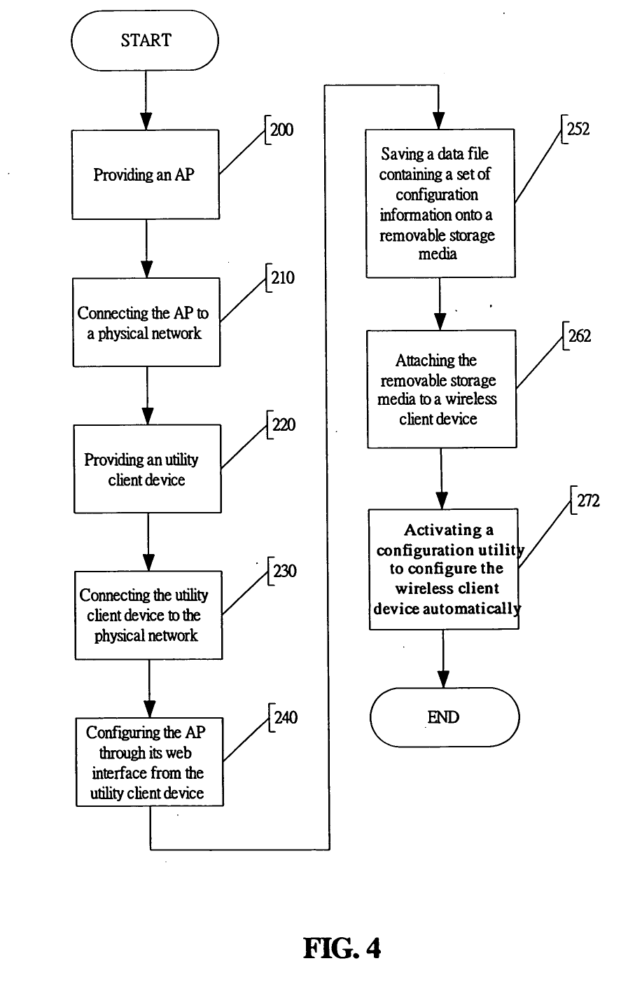

FIG. 4 is a flowchart illustrating the process of setting up a WLAN according to the second embodiment of the present invention. With reference to FIG. 4, all processing steps that are identical to those of the foregoing first embodiment are numbered identically. The only three exceptions lie in steps 252, 262, and 272. For simplicity sake, only these steps are explained as follows. Please also refer to FIGS. 3(a)˜3(e) for devices referred in the following description.

In step 252, after operation parameters of the AP 10 is configured, the user selects to package a copy of a pre-determined set of configuration information relevant to the configuration of the wireless client devices afterwards into a data file (not shown) via the AP 10's web interface. The data file is then downloaded to the browser program of the utility client device 28 and saved onto the removable storage media 50 specified by the user via the web interface. After the data file is saved, the removable storage media 50 could be detached from the utility client device 28. In the present embodiment, the data file is in a format recognizable by the operating system of the wireless client device 32.

Next, in step 262, the removable storage media 50 is inserted into a wireless client device 32 to be connected to the AP 10 in a wireless network. The wireless client devices 32 may include, but not limited to, desktop computers, notebook computers, PDAs, and wireless printer servers, all having capability to accept, recognize, and access the removable storage media 50. More specifically, the wireless client device 32 has a device interface 34 such as USB to accept the removable storage media 50.

Then, in step 272, a configuration utility of the operating system of the wireless client device 32 is triggered automatically after the operating system detects the presence of the data file in the removable storage media 50 (such as when an USB flash drive containing the data file is plugged into an USB port of a notebook computer). In another embodiment of the present invention, the operating system is directed to access the data file by a user of the wireless client device 32 manually via a human-machine interface (such as by pressing a button on the wireless printer server or by using the keyboard and display of the wireless client 32). Then, based on the set of configuration information stored in the data file, the wireless communication interface of the wireless client device 32 is configured automatically by the configuration utility of the operating system. If there are more wireless client devices to set up, the steps 262 and 272 are repeated.

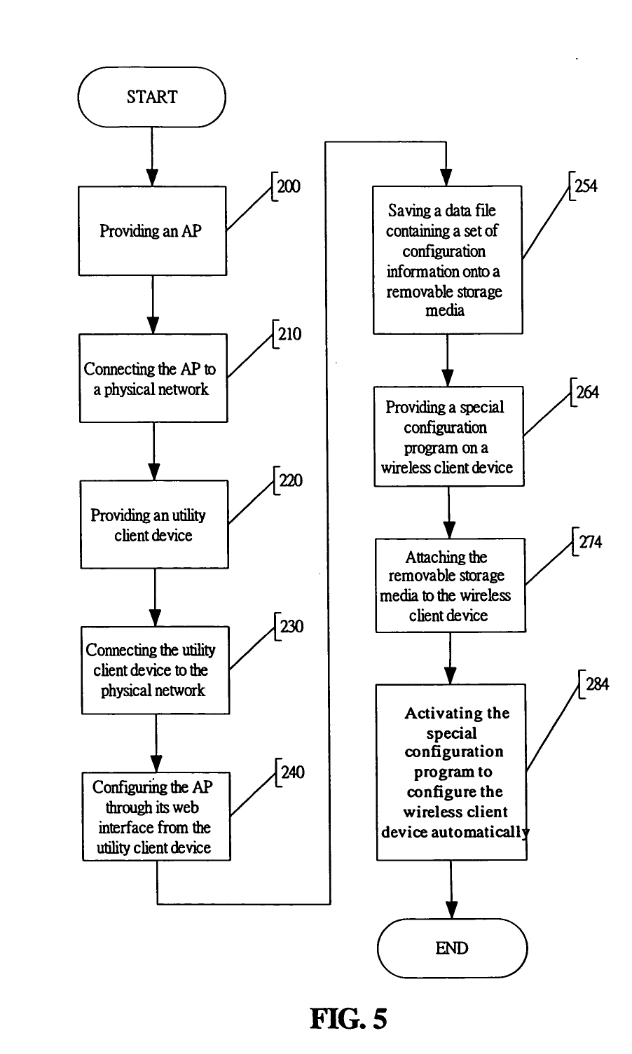

FIG. 5 is a flowchart illustrating the process of setting up a WLAN according to the third embodiment of the present invention. With reference to FIG. 5, all processing steps that are identical to those of the foregoing first and second embodiment are numbered identically. The only exceptions lie in steps 254, 264, 274, and 284. For simplicity sake, only these steps are explained as follows. Please also refer to FIGS. 3(a) to 3(e) for devices referred in the following description.

In step 254, after operation parameters of the AP 10 is configured, the user selects to package a copy of a pre-determined set of configuration information relevant to the configuration of the wireless client devices afterwards into a data file (not shown) via the AP 10's web interface. The data file is in a format recognizable by a special configuration program installed on the wireless client device 32. The data file is then downloaded to the browser program of the utility client device 28 and saved onto the removable storage media 50 specified by the user via the web interface. After the data file is saved, the removable storage media 50 could be detached from the utility client device 28.

Next, in step 264, a wireless client device 32 to be connected to the AP 10 via a wireless network is provided with the special configuration program installed by a user of the wireless client device 32. In another embodiment of the present invention, the special configuration program can be installed any time prior to the set up of the AP 10.

Next, in step 274, the removable storage media 50 is inserted into a wireless client device 32 to be connected to the AP 10 in a wireless network. The wireless client devices 32 may include, but not limited to, desktop computer, notebook computers, PDAs, wireless printer server, all having the capability to accept, access, and recognize the removable storage media 50. More specifically, the wireless client device 32 has a device interface 34 such as USB to accept the removable storage media 50.

Then, in step 284, the special configuration program of the wireless client device 32 is invoked automatically by the operating system of the wireless client device after the operating system detects the presence of the data file in the removable storage media 50. In another embodiment, the special configuration program is invoked manually by a user of the wireless client device 32 (such as by pressing a button on the wireless printer server, or by using the keyboard and display of the wireless client device 32). The special configuration program then accesses the set of configuration information stored in the data file and, based on the set of configuration information, configures the wireless communication interface of the wireless client device 32. If there are more wireless client devices to set up, the steps 264, 274, and 284 are repeated.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for configuring wireless devices in a local area network comprising at least a physical network connected by a physical transmission media and at least a wireless network connected by radio transmission, comprising the steps of:
(a) providing an AP having a default address, a physical network interface for connecting to said physical network, a wireless network interface providing a radio coverage for said wireless network, and a built-in configuration software module providing a web interface with which a user is able to configure said AP and instruct said configuration software module to package a pre-determined set of configuration information relevant to a correct configuration of a wireless interface of a wireless device into a configuration module;
(b) connecting said AP to said physical network by linking said physical transmission media with said physical network interface of said AP;
(c) providing a utility client device having a human-machine interface, a physical network interface, a built-in browser program, and at least a removable storage media;
(d) connecting said utility client device to said physical network by linking said physical transmission media with said physical network interface of said utility client device;
(e) executing said browser program of said utility client device, establishing a connection to said AP by specifying said AP's default address in said browser program, displaying said web interface via said utility client device's human machine interface by said browser program;
(f) configuring said AP's operation parameters, selecting an appropriate execution program format executable on a wireless device whose wireless interface is to be configured later, and selecting an appropriate removable storage media of said utility client device accessible by a wireless device whose wireless interface is to be configured later, all via said web interface;
(g) activating said configuration software module, via said web interface, to generate a configuration module containing an executable program according to said execution program format along with said pre-determined set of configuration information, download said configuration module into said utility client device, and save said configuration module into a removable storage media of said utility client device selected by said user;
(h) inserting said removable storage media into a wireless device, said wireless device having a wireless interface for communicating with other wireless devices; and
(i) executing said executable program of said configuration module in said removable storage media, said executable program utilizing said pre-determined set of configuration information of said configuration module to automatically configure said wireless interface of said wireless device.

2. The method as claimed in claim 1, wherein said configuration software module is stored in a non-volatile memory device of said AP.

3. The method as claimed in claim 1, wherein said removable storage media is selected from the group comprising floppy disk, recordable laser disk, USB flash drive, and USB hard disk drive.

4. The method as claimed in claim 1, wherein said operation parameters comprises SSID, network address, communication channel used to communicate with other wireless devices, whether to turn on WEP protocol, and a security key used.

5. The method as claimed in claim 1, wherein said pre-determined set of configuration information is encapsulated in said executable program.

6. The method as claimed in claim 1, wherein said pre-determined set of configuration information is stored in a separate data file within said configuration module along with said executable program.

7. The method as claimed in claim 1, wherein said executable program is executed automatically by an operating system of said wireless device when said operating system detects said executable program in said removable storage media after said removable storage media is inserted into said wireless device.

8. The method as claimed in claim 1, wherein said executable program is executed manually by a user of said wireless device through a human-machine interface of said wireless device.

9. The method as claimed in claim 1, wherein said steps (h) and (i) are repeated for additional wireless devices that can access said removable storage media and execute said executable program.

10. The method as claimed in claim 1, wherein said wireless device is a device selected from the group comprising a desktop computer, a notebook computer, a PDA, a wireless printer server, and an AP.

11. A method for configuring wireless devices in a local area network comprising at least a physical network connected by a physical transmission media and at least a wireless network connected by radio transmission, comprising the steps of:
(a) providing an AP having a default address, a physical network interface for connecting to said physical network, a wireless network interface providing a radio coverage for said wireless network, and a built-in configuration software module providing a web interface with which a user is able to configure said AP and instruct said configuration software module to package a pre-determined set of configuration information relevant to a correct configuration of a wireless interface of a wireless device into a configuration module;
(b) connecting said AP to said physical network by linking said physical transmission media with said physical network interface of said AP;
(c) providing a utility client device having a human-machine interface, a physical network interface, a built-in browser program, and at least a removable storage media;
(d) connecting said utility client device to said physical network by linking said physical transmission media with said physical network interface of said utility client device;
(e) executing said browser program of said utility client device, establishing a connection to said AP by specifying said AP's default address in said browser program, displaying said web interface via said utility client device's human machine interface by said browser program;
(f) configuring said AP's operation parameters, selecting an appropriate data file format accessible by a wireless device whose wireless interface is to be configured later, and selecting an appropriate removable storage media of said utility client device accessible by a wireless device whose wireless interface is to be configured later, all via said web interface;
(g) activating said configuration software module, via said web interface, to generate a data file according to said data file format containing said pre-determined set of configuration information, download said data file into said utility client device, and save said data file into a removable storage media of said utility client device selected by said user;
(h) inserting said removable storage media into a wireless device, said wireless device having a wireless interface for communicating with other wireless devices; and
(i) utilizing said pre-determined set of configuration information in said data file to automatically configure said wireless interface of said wireless device.

12. The method as claimed in claim 11, wherein said configuration software module is stored in a non-volatile memory device of said AP.

13. The method as claimed in claim 11, wherein said removable storage media is selected from the group comprising floppy disk, recordable laser disk, USB flash drive, and USB hard disk drive.

14. The method as claimed in claim 11, wherein said operation parameters comprises SSID, network address, communication channel used to communicate with wireless devices, whether to turn on WEP protocol, and a security key used.

15. The method as claimed in claim 11, wherein said data file is utilized by a configuration utility of an operating system of said wireless device; said configuration utility is invoked automatically when said operating system detects said data file in said removable storage media after said removable storage media is inserted into said wireless device.

16. The method as claimed in claim 11, wherein said data file is utilized by a configuration utility of an operating system of said wireless device; said configuration utility is invoked manually by a user of said wireless device through a human-machine interface of said wireless device.

17. The method as claimed in claim 11, wherein said data file is utilized by a configuration program pre-installed in said wireless device; said configuration program is invoked automatically when said operating system detects said data file in said removable storage media after said removable storage media is inserted into said wireless device.

18. The method as claimed in claim 11, wherein said data file is utilized by a configuration program pre-installed in said wireless device; said configuration program is invoked manually by a user of said wireless device through a human-machine interface of said wireless device.

19. The method as claimed in claim 11, wherein said steps (h) and (i) are repeated for additional wireless devices that can access said removable storage media and said data file.

20. The method as claimed in claim 11, wherein said wireless device is a device selected from the group comprising a desktop computer, a notebook computer, a PDA, a wireless printer server, and an AP.
